(19) United States
(12) Patent Application Publication
(10) Pub. No.: US 2024/0252962 A1
(43) Pub. Date: Aug. 1, 2024

(54) Filter Apparatus

(71) Applicant: HYDAC Process Technology GmbH, Neunkirchen (DE)

(72) Inventors: Bernhard Schlichter, Saarbrücken (DE); Jörg Hermann Gerstner, Püttlingen (DE); Manfred Deutschmeyer, Perl (DE); Dimitri Bugrov, Marpingen (DE)

(73) Assignee: HYDAC Process Technology GmbH, Neunkirchen (DE)

(21) Appl. No.: 18/692,266

(22) PCT Filed: Sep. 19, 2022
(86) PCT No.: PCT/EP2022/075944

§ 371 Date: Mar. 15, 2024

(30) Foreign Application Priority Data
Sep. 21, 2021 (DE) 10 2021 004 750.8

(51) Int. Cl. B01D 36/02; B01D 24/08; B01D 24/46; B01D 29/15; B01D 29/68; B01D 39/02

(52) U.S. Cl. CPC B01D 36/02; B01D 24/08; B01D 24/4636; B01D 29/15; B01D 29/682; B01D 39/02; B01D 2239/0428

(57) ABSTRACT

The invention relates to a filter apparatus, in particular in the form of a hollow cylinder (10) having a filter material (12), characterized in that a pre-filter (16) is mounted upstream of a surface filter (14) in the flow direction of a fluid stream to be cleaned from particulate contaminants, which pre-filter comprising a bulk material (18) for increasing the effective surface of the filter material (12), which bulk material is received between delimiting layers (20, 22) which are in each case provided with holes for fluids, the opening width of which is smaller than the diameter of a single grain (24) of the bulk material (18).

### CROSS-REFERENCE TO RELATED APPLICATIONS

This application claims priority to German Patent Application No. DE 10 2021 004 750.8, filed on Sep. 21, 2021 with the German Patent and Trademark Office. The contents of the aforesaid Patent Application are incorporated herein for all purposes.

### BACKGROUND

This background section is provided for the purpose of generally describing the context of the disclosure. Work of the presently named inventor (s), to the extent the work is described in this background section, as well as aspects of the description that may not otherwise qualify as prior art at the time of filing, are neither expressly nor impliedly admitted as prior art against the present disclosure.

The disclosure generally relates to a filter apparatus, in particular in the form of a hollow cylinder having a filter material.

DE 10 2019 006 765 A1 discloses a method for producing a multi-layer filter medium and a filter medium produced according to this method, the method comprising at least the following production steps:
providing a fabric layer which has passage points for fluid;
providing a nonwoven layer consisting of a spunbond nonwoven which has further passage points for fluid; and
joining the two superimposed layers along contact points by melting the nonwoven layer in such a manner that the melted spunbond nonwoven runs at least in part to the contact points, while enlarging the further passage points, and subsequently creates solid joints between the two layers, having accumulated there and hardened.

In contrast to other known filter media solutions involving sintering wire meshes together, mechanical stabilisation is achieved by using a meltblown nonwoven as the nonwoven layer.

In this case, the weight per unit area of the meltblown nonwoven is selected in such a manner and the thermal meltbonding process is carried out in such a manner that the meltblown nonwoven creates an intermediate space with high porosity between the wire meshes to be joined.

The filter elements produced with the said filter medium are provided as backflush elements, in particular for use in backflushing filter devices, such as are illustrated by way of example in DE 10 2017 002 646 A1, DE 10 2017 001 970 A1 and DE 10 2019 003 932 A1.

The filter elements referred to are particularly suitable for solid/liquid separation of low-viscosity fluids and are important in water filtration. However, as filtration continues, the filter pores of the filter material become increasingly covered by dirt particles and clogged in a manner that is also referred to in technical terminology as blocking. Then, as the pick-up of dirt increases, the differential pressure measured upstream and downstream of the filter material inevitably increases correspondingly quickly and the filter apparatus initiates the backflushing process described above at a specific differential pressure. The lower the dirt holding capacity of the filter material and the more frequently it becomes blocked, the more often the filter material has to be cleaned by reversing the flow before it can be used for filtration again. However, the shorter the filtration intervals of the apparatus become, the more frequently backflushing takes place per unit of time which, on the one hand, produces more backflushing liquid, routinely in the form of wastewater, and depending on the dirt content in the water, a correspondingly large backflushing filter is required for effective regeneration.

### SUMMARY

A need exists to provide an improved filter solution.

The need is addressed by the subject matter of the independent claim(s). Embodiments of the invention are described in the dependent claims, the following description, and the drawings.

### BRIEF DESCRIPTION OF THE DRAWINGS

FIG. 1 a partially cut-away view of an example hollow filter cylinder as a whole;

FIG. 2 an enlarged view of a circular detail denoted by X in FIG. 1; and

FIG. 3 a partial detail of the filter cylinder according to FIG. 1 viewed from above, as it appears when the upper end cap ring is removed.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, a prefilter is connected upstream of a surface filter in the flow direction of a fluid flow to be cleaned of particulate contamination, which prefilter comprises a bulk material for increasing the effective surface area of the filter material. The bulk material is accommodated between confining layers, each of which is provided with fluid passages, the opening width of which is smaller than the diameter of a single grain of the bulk material. The dirt holding capacity of the filter apparatus or the filter element is thus increased in such a way that the filtration intervals are significantly longer compared to conventional element constructions, as described above, under otherwise identical process conditions.

The additional pore volume created by the filling upstream of the actual filter material of the surface filter increases the dirt holding capacity of the overall filter accordingly, so that the differential pressure required to trigger backflushing is reached comparatively later. Since the filling, which among other things contributes to the filter fineness of the overall filter, represents additional resistance for particle filtration, the initial differential pressure is somewhat higher compared to conventional filter apparatuses with filter cylinders. In contrast, however, it takes considerably longer for the differential pressure to increase to such an extent that backflushing or regeneration is triggered. All in all, the filter fineness of the overall filter is ultimately determined by the fine weave fabric of a filter. The woven material used is therefore selected to be correspondingly finer than the filling in the form of the bulk material.

Overall, however, the power density is increased for the same apparatus or device size, i.e., the device can treat comparatively larger volume flows. The filtrate quality is also improved. Although a fine filter fabric used as part of the surface filter can theoretically have finer geometric pores than the filling stored in front of it, comparative tests with a conventional filter cylinder with the same fine fabric show higher retention rates when using the solution according to the teachings herein. It can be assumed that in the case of the filter cylinder with filling, the retention of particulate contaminants is no longer due only to size exclusion mechanisms or screen effects but that adsorptive processes are also increasingly important. In any case, the prefilter in the form of the filling is accommodated between confining layers which on one side at least can also be part of the surface filter, with opening widths which prevent unwanted escape of the granular bulk material from the prefilter layer. In this way, retention of the filling in the prefilter upstream of the surface filter is guaranteed even during highly dynamic filtration and backflushing operation.

In this case the two confining layers for example form a thin cylinder wall of the hollow cylinder, the width of which is for example 1 to 10%, for example 2 to 6%, for example 2.5% of the free diameter of the hollow cylinder. In this way, all active filter media are combined in the thin cylinder wall so that the interior of the hollow cylinder is largely available as an unobstructed flow space, with the result that a high throughput of volume flow is achieved and there is no intentional aim for high dwell times of the fluid flow in the filter medium, as is the case in known filters when more or less the entire internal space of the hollow cylinder is filled with the respective filter medium, also in free-flowing form. In this way, using the filter apparatus according to the teachings herein achieves an extremely effective surface filter solution which furthermore can also be backflushed very well in the opposite direction for the purpose of cleaning the filter medium. This thus has no equivalent in prior art.

In some embodiments, it is provided that the bulk material consists of inorganic, metallic or organic materials of natural or synthetic origin. In particular, recycled materials can also be used here, such as cullet made from waste glass and the like. In this way, there can be CO₂ savings and the filling can be obtained from waste materials in a climate-neutral manner.

It is for example further provided that the grain size for the single grain is between 0.1 and 2 mm with a fill height of the bulk material between the two confining layers of the filter that is between 5 to 50 mm, for example between 10 to 30 mm. In this way, an optimum is achieved in terms of particle retention, without the filling adversely affecting the flow resistance for the flowing fluid.

The bulk material may for example be by hydrophobized and/or comprise hydrophobized materials which has the benefit that water entrained in fluids, such as hydraulic oils, cannot inadvertently become incorporated in the bulk material and impair further filtration. In this case, the bulk material is for example made up of sand, silicates, metals, glass, activated carbon (s) and/or plastics in granular form.

In some embodiments, it is provided that the confining layers of the filter and/or the surface filters are formed from wire or plastic meshes or suitable nonwovens. In this way, it is possible to produce wire or plastic meshes with a wide range of weaves that are corrosion-resistant. In addition to the usual meshes made from warp and weft threads, plain Dutch weave meshes can also be used in this way.

In some embodiments, it is provided that the surface filter has a confining layer for the bulk material or forms this confining layer itself. Furthermore, the filter cylinder for example comprises the following components from inside to outside:
an inner supporting body,
a confining layer for confining the bulk material.
bulk material for increasing the surface area of the surface filter,
optionally a further confining layer,
a surface filter,
a support fabric for supporting the surface filter,
an outer supporting body.

The further confining layer can be optional as the subsequent fine mesh, which acts as a surface filter and determines the filter fineness of the overall filter, can retain the filling. The support mesh for supporting the surface filter is virtually essential to be able to support the fine mesh on the subsequent supporting body. In this case, the surface filter material can be constructed from a wide range of different materials (inorganic/ceramic, organic or metallic), for example as a mesh or nonwoven consisting of stainless steel or plastic. The filter fineness for the surface material is for example selected to be smaller than the average geometric pore resulting for the filling, which co-determines the filter fineness for the entire filter cylinder. Thus, fine stainless steel meshes of many different weaves, for example in square mesh or plain Dutch weave design, can be used for the surface filter material; typically with geometric pores ranging from 1 to 100 μm, for example ranging from 10 to 50 μm.

In some embodiments, it is provided that the inner and/or the outer supporting bodies are formed of a perforated sheet, a wedge wire screen or a wire mesh. It is for example further provided that the outer supporting body has a circumferential spiral-shaped wire protruding outwards towards the environment. The aforementioned arrangement is used overall to stabilise the filter body, in particular against burst pressure. The respective supporting body can for example be connected, particularly bonded, to the end caps limiting the filter cylinder. Bonding is beneficially in that it prevents any vestigial air pockets in the filling and also ensures sealing across all layers.

The filter apparatus according to the invention is explained in greater detail in the following with reference to an embodiment according to the drawings. The drawings show in principle and not to scale.

Reference will now be made to the drawings in which the various elements of embodiments will be given numerical designations and in which further embodiments will be discussed.

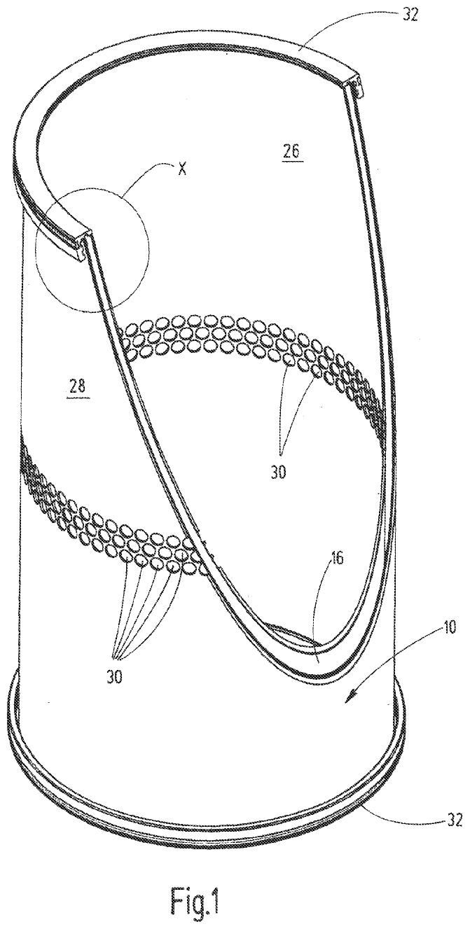

FIG. 1 shows a filter apparatus as a whole in the form of a hollow filter cylinder 10. Such hollow cylinders 10, which can consist of a plurality of filter cartridges arranged one above the other as part of a stacked assembly (not shown), are regularly provided in filter housings for replaceable mounting, as illustrated by way of example in DE 10 2017 001 968 A1. Such hollow filter cylinders 10 regularly have a fluid flow which passes through from inside to outside, the particle contamination in which flow is deposited on the inside of a filter material 12. A backflushing device (not shown) arranged centrally on the inside of the hollow cylinder 10 has individual nozzle-like cleaning units rotating along the inside of the hollow cylinder 10 by means of a rotatably arranged backflush arm, which, when subjected to the filtrate pressure on the outside of the hollow cylinder 10, enable backflushing of the filter material 12 from outside to inside and the cleaned particles are discharged from the overall filter as backflush fluid via the respective cleaning unit and the backflush arm, through a corresponding outlet in the filter housing.

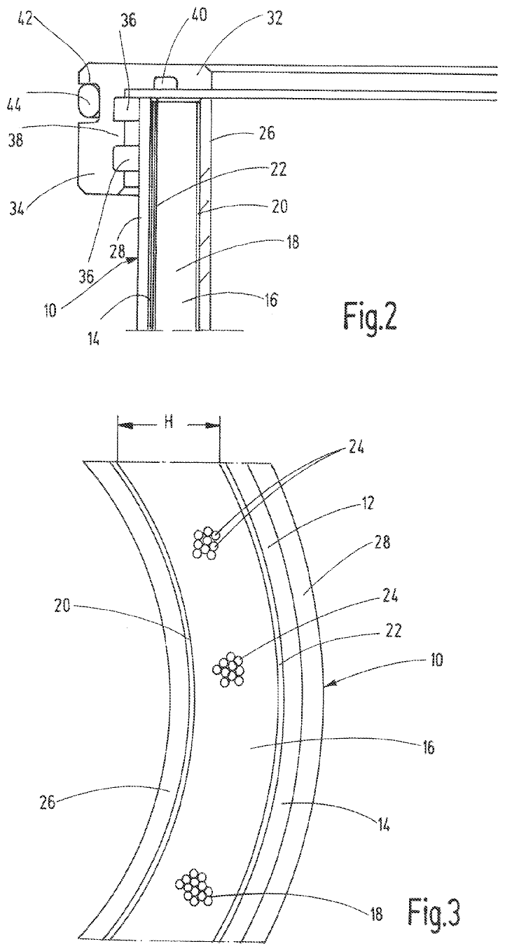

As FIGS. 2 and 3 show in particular, the filter material 12 of the hollow cylinder 10 has a surface filter 14 which is preceded by a prefilter 16 in the flow direction of the fluid flow that is to be cleaned of particulate contamination, from inside to outside. The aforementioned prefilter 16 comprises a bulk material 18 which is used to increase the effective surface area of the filter material 12 and which is accommodated between two confining layers 20, 22, each of which is provided with fluid passages of a predefinable size, the opening width of which is in any case smaller than the diameter of a single grain 24 of the bulk material 18, in order to prevent the granular bulk material 18 from being unintentionally washed out of the filter. The term filter material 12 is the generic term for all filter components used, such as the surface filter 14 or the bulk material 18.

The bulk material 18 for increasing the surface area of the filter material 12 upstream of the surface filter 14 can consist of inorganic, metallic or organic materials of natural or synthetic origin. Recycled materials can also be used, such as cullet made from waste glass. As the filling, mixtures of the above-mentioned materials can also be used for the bulk material 18 as required, as well as so-called composite materials which combine at least two of the above-mentioned materials in one grain 24 in each case. Furthermore, surface modification can be considered, for example by hydrophobizing the respective grain 24.

In order to create a surface area which is as large as possible, individual grains 24 in spherical form are also used for the filling, the typical grain sizes being between 0.1 and 2 mm. The fill height between the two confining layers 20 and 22, denoted by H in FIG. 3, is 5 to 50 mm, for example 10 to 30 mm. The respective filling, consisting for example of sand, silicates, metals, cullet or glass beads, activated carbon (s), plastics, etc., is most easily poured in from above between the two confining layers 20 and 22 as seen in the viewing direction of FIGS. 1 and 2, no compaction of the bulk material 18 being necessary. Rather, an even distribution can be achieved as required using vibration processes on the hollow filter cylinder 10.

The surface filter 14 can also be constructed for its filter material 12 with surface filter properties from a wide range of different materials (inorganic/ceramic, organic or metallic) and for example consists of a mesh or nonwoven which in turn is constructed from stainless steel or plastic materials. The filter fineness of the surface filter material is for example less than the average geometric pore of the filling in respect of the bulk material 18, and the filter fineness of the overall hollow cylinder 10 or the filter apparatus is ultimately determined by the geometric pores of the fine filter mesh 12 or 14. Thus fine stainless steel meshes of many different weaves, for example in square mesh or plain Dutch weave design, typically with geometric pores ranging from 10 to 50 μm, can for example be used for the surface filter 14. In this respect, the surface material itself can form a confining layer for the bulk materials 18, and in this respect the confining layer 22 could then be omitted as an independent component within the filter layer composite.

The two fabrics for confining the filling in the form of the inner confining layer 20 and the outer confining layer 22 are provided in any case with a pore width which is smaller than the grain 24 of the filling and typically ranges from 50 to 200 μm. The meshes can also be made of wire materials in plastic construction with a wide range of weaves.

Furthermore, the filter layer composite for the hollow cylinder 10 comprises an inner supporting body 26 and an outer supporting body 28. The aforementioned supporting bodies 26 and 28 are used to stabilise the filter body as a whole against collapse pressure and, in the present case, a perforated plate with circular fluid passages 30 is used to this effect, of which only a detail with the said fluid passages 30 is shown in FIG. 1, for the sake of simplicity, but which normally extend circumferentially over the entire height of the hollow cylinder 10. Instead of the perforated sheet shown, the supporting bodies 26 and 28 can also be constructed of a wedge wire screen or wire mesh, a circumferential spirally arranged wire, not shown in greater detail, being able to hold the mesh arrangement in position and for example stiffening it further.

As FIG. 1 shows in particular, to complete the hollow cylinder 10, the filter material 12 referred to is enclosed on its free end faces by an annular end cap 32 in each case, the upper end cap ring 32 not being shown in greater detail in FIG. 2. In this case, the end cap ring 32 overlaps the upper end region of all individual layers of the filter cylinder 10 with a protrusion 34 and on its side directed towards the outer supporting body 28 has two circumferential grooves 36 which are separated from each other by a central ligament 38. In addition, the ring 32 has a further circumferential inner groove 40 on its inner side directed towards the end face of the filter layers. The aforementioned grooves 36 and 40 can be used to receive an adhesive, not shown in greater detail, which, when cured in the manner of an adhesive bed, permanently joins the annular end cap 32 to the other layers of the hollow filter cylinder 10 and, in particular, ensures that the filling or the bulk material 18 remains in position towards the outside at the free ends of the aforementioned bed of bulk material between the confining layers 20 and 22. On the inner circumference, the ring 32 is flush with the inner circumference of the inner supporting body 26 and on the opposing side, an O sealing ring 44 is received in an annular groove 42 of the ring 32, which serves to seal the hollow cylinder 10 later when it is received in an associated filter housing of an overall filter.

To use the hollow cylinder 10 in backflushing filters of the type mentioned, it may possibly be necessary to make modifications to the flushing device. For example, the flushing gap dimensions will have to be adjusted to the specific cylinder configuration. It may also be necessary to make adjustments to the process control during backflushing, for example when it comes to adjusting the rotational speed of the backflushing device. In technical terms, the hollow filter cylinder 10 described above is also referred to as a so-called filter basket, although it does not actually have a basket base. In a further development of the hollow filter cylinder 10, however, it is also entirely possible to equip the aforementioned screen cylinder with a fluid-tight end cap (not shown) for special applications. The base of the basket in question then for example forms the one end cap for the entire filter cylinder 10.

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfil the functions of several items recited in the claims.

The term “exemplary” used throughout the specification means “serving as an example, instance, or exemplification” and does not mean “preferred” or “having advantages” over other embodiments. The term “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1-13. (canceled)

14. A filter apparatus, having a filter material, wherein a prefilter is connected upstream of a surface filter in the flow direction of a fluid flow to be cleaned of particulate contamination, which prefilter comprises a bulk material for increasing the effective surface area of the filter material, which bulk material is accommodated between confining layers, each of which is provided with fluid passages, the opening width of which is smaller than the diameter of a single grain of the bulk material.

15. The filter apparatus of claim 14, wherein the two confining layers form a thin cylinder wall of the hollow cylinder, the width of which is between 1% to 10%, 2% to 6%, or 2.5% of the free diameter of the hollow cylinder.

16. The filter apparatus of claim 14, wherein the bulk material consists of inorganic, metallic or organic materials of natural or synthetic origin.

17. The filter apparatus of claim 14, wherein the fill height of the bulk material between the two confining layers is between 5 mm and 50 mm, or between 10 mm and 30 mm.

18. The filter apparatus of claim 14, wherein the bulk material is hydrophobized and/or comprises hydrophobized materials.

19. The filter apparatus of claim 14, wherein the bulk material consists of one or more of sand, silicates, metals, glass, activated carbon (s), and plastics in granular form.

20. The filter apparatus of claim 14, wherein the confining layers and/or the surface filter are formed of wire or plastic meshes or nonwovens.

21. The filter apparatus of claim 14, wherein the surface filter has a confining layer for the bulk material or forms this boundary layer itself.

22. The filter apparatus of claim 14, wherein the hollow cylinder comprises the following components from inside to outside:
an inner supporting body;
a confining layer for confining the bulk material;
bulk material for increasing the surface area of the surface filter;
optionally a further confining layer;
a surface filter;
a support fabric for supporting the surface filter; and
an outer supporting body.

23. The filter apparatus of claim 14, wherein the components used in each case extend concentrically to the longitudinal axis of the hollow cylinder.

24. The filter apparatus of claim 14, wherein the cylinder wall with its respective components is enclosed on its free end faces by a respective end cap ring.

25. The filter apparatus of claim 14, wherein the inner and/or the outer supporting bodies are formed of a perforated sheet, a wedge wire screen or a wire mesh.

26. The filter apparatus of claim 14, wherein the outer supporting body has a circumferential, spiral-shaped wire protruding outwards towards the environment.

27. The filter apparatus of claim 14, wherein the filter apparatus in the form of a hollow cylinder.

28. The filter apparatus of claim 14, wherein the bulk material consists of inorganic, metallic or organic materials of natural or synthetic origin with a grain size for a single grain of between 0.1 mm and 2 mm.

29. The filter apparatus of claim 15, wherein the bulk material consists of inorganic, metallic or organic materials of natural or synthetic origin.

30. The filter apparatus of claim 15, wherein the bulk material consists of inorganic, metallic or organic materials of natural or synthetic origin with a grain size for the single grain of between 0.1 mm and 2 mm.

31. Filter apparatus of claim 15, wherein the fill height of the bulk material between the two confining layers is between 5 mm and 50 mm, or between 10 mm and 30 mm.

32. Filter apparatus of claim 16, wherein the fill height of the bulk material between the two confining layers is between 5 mm and 50 mm, or between 10 mm and 30 mm.

33. The filter apparatus of claim 15, wherein the bulk material is hydrophobized and/or comprises hydrophobized materials.
